(19) United States
(12) Patent Application Publication
(10) Pub. No.: US 2012/0129066 A1
(43) Pub. Date: May 24, 2012

(54) DEVICE AND METHOD FOR COOLING A THERMAL MEMBER IN AN AUTOMOBILE

(75) Inventors: Fehd Ben-Aicha, Guyancourt (FR); Karim Bencherif, Puteaux (FR)

(73) Assignee: RENAULT S.A.S., Boulogne-Billancourt (FR)

(21) Appl. No.: 13/141,611

(22) PCT Filed: Nov. 26, 2009
(86) PCT No.: PCT/FR2009/052305

§ 371 Date: Feb. 13, 2012

(30) Foreign Application Priority Data
Dec. 22, 2008 (FR) 0858913

(51) Int. Cl. H01M 8/04; F01P 7/16

(52) U.S. Cl. 429/435; 429/434

(57) ABSTRACT

A cooling device includes a main cooling circuit capable of adjusting the temperature of a thermal member, a secondary cooling circuit including a first assembly of at least two heat exchangers mounted in parallel, and a thermal coupling between the main cooling circuit and the secondary cooling circuit. The cooling device also includes a temperature sensor mounted in series on the secondary cooling circuit and downstream from the first assembly, and a control unit including an estimator to estimate, with a state monitor, the outlet temperature of each heat exchanger of the first assembly from the inlet temperature of a coolant at the inlet of each heat exchanger of the first assembly and from the values measured by the temperature sensor.

The invention relates to thermal members for automobiles and, more particularly, to cooling devices for such members.

A particularly advantageous application of the invention relates to the cooling of fuel cell systems, in particular those comprising an integrated reforming device used to produce hydrogen for the cell.

Fuel cells are designed to produce electrical energy from a hydrogen oxidation reaction on the anode and an oxygen reduction reaction on the cathode. The overall reaction is expressed as:

½O₂+H₂→H₂O+Electricity+Heat.

Thus, in a fuel cell system, chemical energy is transformed into electrical energy. The reactions which take place inside the cell also produce heat which has to be discharged in order to ensure the correct operation of the cell, to increase the service life thereof and to improve the overall efficiency of the system.

In a fuel cell system provided with an integrated reformer, the quantity of heat released by the chemical reactions is considerable. This is in the order of 60 kW for a cell which has a power in the order of 75 kW. The nominal operating temperature level of the fuel cell system is relatively low, which makes the thermal regulation of the system relatively difficult to implement.

Moreover, water constitutes one of the main reagents of the reactions which take place in the reformer. To provide the required quantity of water, condensers and separators are distributed along the path of the waste gases from the power module in order to collect, by cooling, the water produced by the fuel cell. However, this further increases the quantity of heat to be discharged.

As regards internal combustion engines, it is estimated that approximately a third of the energy has to be dissipated by the cooling circuit. Moreover, it is also necessary to cool the engine oil, in addition to the auxiliary circuits such as the electrical circuits.

Cooling circuits are, for example, disclosed in the applications GB 2 409 763 and US 2005/0227125.

Conventional cooling devices for fuel cells or internal combustion engines for automobiles may comprise two cooling circuits, namely a main cooling circuit used to cool the cell or the internal combustion engine, and a secondary cooling circuit which is in a heat exchange relationship with the main cooling circuit by means of a heat exchanger.

In this type of cooling device, the secondary cooling circuit comprises further heat exchangers in order to discharge the thermal energy collected from the traction system or even to provide thermal energy. However, the control of the different exchanges of thermal energy requires the use of numerous temperature sensors.

The object of the invention is, therefore, to remedy this drawback.

A further object of the invention is to propose a cooling device for a thermal member of an automobile which also permits potential breakdowns to be diagnosed.

The subject of the invention, therefore, according to a first feature, is a cooling device for a thermal member, in particular used in a traction system of an automobile, comprising a main cooling circuit capable of regulating the temperature of the thermal member, a secondary cooling circuit comprising a first assembly of at least two heat exchangers mounted in parallel, and a thermal coupling means between the main cooling circuit and the secondary cooling circuit. The cooling device further comprises a temperature sensor mounted in series on the secondary cooling circuit and downstream of the first assembly and a control unit comprising a first means capable of estimating, by means of a state observer, for example a high gain state observer, the outlet temperature of each heat exchanger of the first assembly from the inlet temperature of the coolant at the inlet of each heat exchanger of the first assembly and variables measured by the temperature sensor.

Thus it is possible to determine the temperature at different points of the cooling device and, in particular, in the region of the heat exchangers of the first assembly whilst limiting the number of sensors inside the device.

According to a further feature of the invention, the secondary cooling circuit may comprise a bypass of which one end is mounted downstream of the temperature sensor and upstream of the thermal contact means, and of which the other end is mounted downstream of the first assembly of heat exchangers and upstream of the temperature sensor, the bypass comprising a second assembly of at least two heat exchangers mounted in parallel.

In this case, the first means may also be capable of estimating, by means of a state observer, for example a high gain state observer, the outlet temperature of each heat exchanger of the second assembly from the inlet temperature of the coolant at the inlet of each heat exchanger of the second assembly and variables measured by the temperature sensor.

Thus, the first means of the electronic control unit may be used to determine both the outlet temperatures of the heat exchangers of the first assembly and of the second assembly.

The secondary cooling circuit may further comprise first and second radiators, respectively associated with the first and second assemblies of exchangers.

In this case, the cooling device may also comprise adjustable means for short-circuiting the first and second radiators and the control unit may also comprise a third means for controlling the adjustable means for short-circuiting the first and second radiators.

According to an embodiment of the invention, the control unit comprises a second means capable of determining the inlet temperature of the coolant at the inlet of each heat exchanger from variables measured by the temperature sensor.

In particular, from operating equations of the heat exchangers, and from other variables of the system, the second means may determine the temperature of the coolant at the inlet of each exchanger, which makes it possible to reduce the number of temperature sensors in the device.

According to a further embodiment of the invention, the cooling device may further comprise temperature sensors capable of measuring the inlet temperature of the coolant at the inlet of each assembly of heat exchangers, and the control unit may comprise a fourth means capable of monitoring the flow rate of coolant circulating in the first and second radiators from variables measured by the temperature sensors.

In this case, the operating equations of the heat exchangers are no longer used to determine the temperature of the coolant at the inlet of the heat exchangers but are used to evaluate the flow rate of coolant circulating in the radiators and thus to enable a breakdown to be diagnosed.

In one embodiment, the thermal member comprises a fuel cell and the thermal contact means is a heat exchanger arranged between the main cooling circuit and the secondary cooling circuit.

In this case, the second assembly of exchangers may enable the temperature of the outlet gases from the fuel cell to be regulated and the third means is capable of controlling the adjustable means to short-circuit the second radiator, depending on the water balance consumed by the fuel cell and collected by the cooling device.

According to a second feature, the subject of the invention is also a method for controlling a device for cooling a thermal member, in particular used in a traction system of an automobile, comprising a main cooling circuit capable of regulating the temperature of the thermal member, a secondary cooling circuit comprising a first assembly of at least two heat exchangers mounted in parallel and a thermal coupling means between the main cooling circuit and the secondary cooling circuit. In particular, according to the method:
the temperature of the coolant is measured downstream of the first assembly of heat exchangers,
the temperature of the coolant of the secondary circuit is determined at the inlet of the heat exchangers, and
by means of a state observer, for example a high gain state observer, the outlet temperature of each of the heat exchangers is estimated from the inlet temperature of the coolant at the inlet of the heat exchangers and the measured temperature of the coolant.

Further objects, features and advantages of the invention will become apparent from reading the following description, given solely by way of non-limiting example and made with reference to the accompanying drawings, in which:

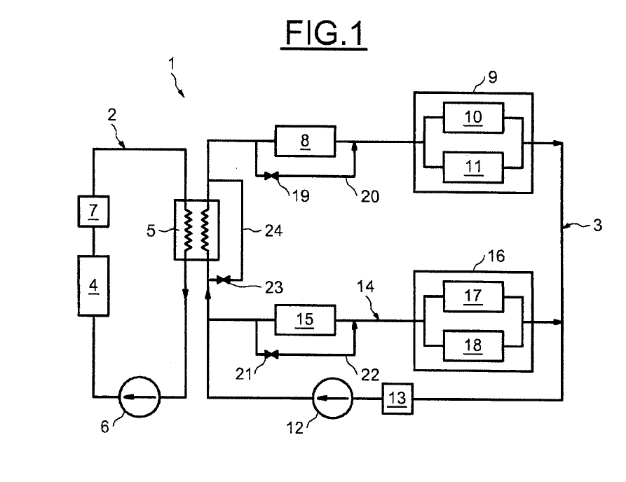

FIG. 1 illustrates the general architecture of a thermal member and the cooling device thereof;

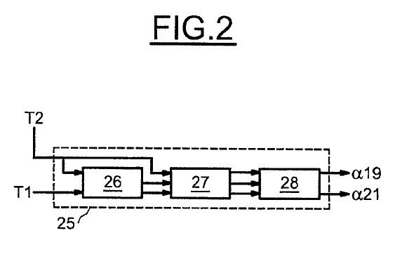

FIG. 2 is a synoptic diagram illustrating the architecture of the means for determining the temperature at different points of the secondary circuit of the cooling device according to a first embodiment of the invention;

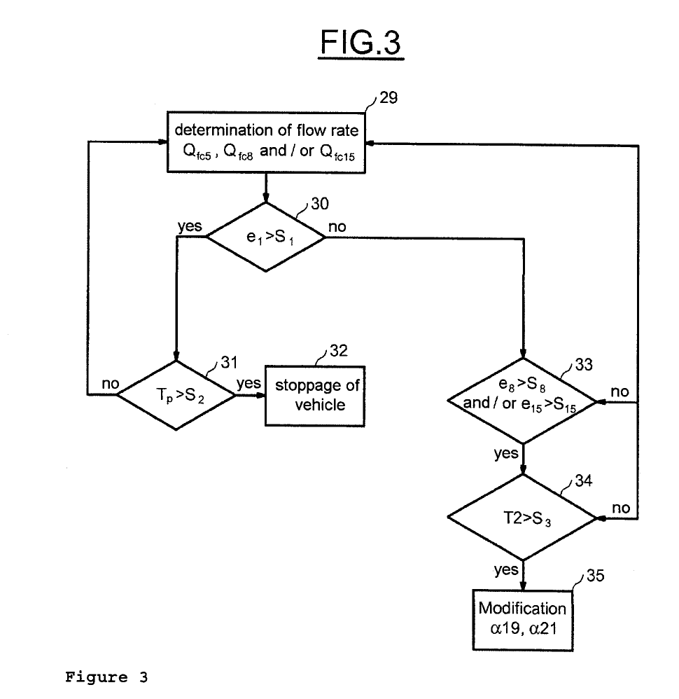

FIG. 3 is a diagram illustrating the implementation of the method for monitoring the secondary cooling circuit according to a second embodiment of the invention.

In FIG. 1 is shown the general architecture of a first embodiment of a cooling device 1 according to the invention and which is capable, on the one hand, of efficiently cooling a thermal member, for example the traction system of the automobile and, on the other hand, of providing or collecting the thermal energy from different elements or fluids circulating in the vehicle.

In this regard, the cooling device 1 visible in FIG. 1 comprises a main circuit 2 and a secondary circuit 3. In particular, the thermal member 4 of the automobile is placed on the main circuit 2.

The cooling device 1 is further provided with a heat exchanger 5 providing thermal coupling between the main circuit 2 and the secondary circuit 3.

As regards the main circuit 2, it essentially comprises a loop in which a coolant circulates, and on which the exchanger 5 and the thermal member 4 are placed. The main circuit 2 also comprises a pump 6 enabling the coolant to be circulated, and a temperature sensor 7 capable of measuring the temperature T1 of the coolant of the main circuit 2 downstream of the thermal member 4.

The secondary circuit 3, in turn, comprises a loop also containing a coolant and thermally coupled to the loop of the main circuit 2 by means of the exchanger 5.

Regarding the circulation of the coolant in the loop of the secondary circuit 3, the loop comprises a first radiator 8. The first radiator 8 is a high-temperature radiator and is placed downstream of the exchanger 5. The first radiator 8 is used, in particular, to discharge the thermal energy removed by the heat exchanger 5 to the coolant circulating in the loop of the main circuit 2. The loop of the secondary circuit 3 also comprises, downstream of the first radiator 8, a first assembly 9 of heat exchangers 10, 11 arranged in parallel and providing the regulation of elements or fluids circulating in the automobile.

The secondary circuit 3 finally comprises a pump 12 and is connected to the inlet of the heat exchanger 5. The pump 12 makes it possible to circulate the coolant of the secondary circuit 3. A temperature sensor 13 capable of measuring the temperature of the coolant of the secondary circuit 3 is mounted upstream of the pump 12 and downstream of the first assembly 9.

The secondary circuit 3 further comprises a bypass 14 used to cool other elements or fluids circulating in the vehicle. The inlet of the bypass 14 is mounted upstream of the heat exchanger 5 and downstream of the pump 12, whilst the outlet of the bypass 14 is mounted downstream of the first assembly 9 and upstream of the temperature sensor 13.

The bypass 14 comprises a second radiator 15. The second radiator 15 is a low-temperature radiator. In particular, the coolant circulating in the second radiator 15 has not passed through the heat exchanger 5: the second radiator thus makes it possible to collect the thermal energy from other elements or fluids of the automobile. The bypass 14 also comprises, downstream of the second radiator 15, a second assembly 16 of heat exchangers 17, 18 arranged in parallel and providing the regulation of elements or fluids circulating in the automobile.

The first and second radiators 8, 15 are provided with first and second adjustable means respectively arranged in parallel with the first and second radiators 8, 15 in order to short-circuit said radiators. More particularly, said first and second adjustable means respectively comprise a first valve 19 mounted on a first bypass pipe 20 and a second valve 21 mounted on a second bypass pipe 22.

The heat exchanger 5, in particular in the region of the secondary circuit 3, is provided with a third adjustable means to short-circuit the exchanger 5. The third adjustable means consists of a third valve 23 mounted on a third bypass pipe 24.

The third valve 23, and the third bypass pipe 24 on which it is mounted, are used in order to permit the decoupling of the control of the main circuit 2 from that of the secondary circuit 3. More particularly, the third adjustable means makes it possible to adjust the temperature of the thermal member 4 without being disrupted by the secondary circuit 3.

Moreover, the first and second valves 19, 21 and the first and second bypass pipes 20 and 22 on which they are mounted, are used to control automatically the temperature of the heat exchangers 10, 11, 17, 18.

According to the type of thermal member 4 of the automobile, the exchangers 10, 11, 17, 18 enable the temperature of the elements or different fluids to be regulated.

Thus, when the thermal member 4 of the automobile comprises an internal combustion engine, the exchangers 10, 11 may be used to regulate, for example, the temperature of the automatic gear box or the temperature of the engine oil, whilst the exchangers 17, 18 may be used to regulate the temperature of the electronic power module or the temperature of an air circuit.

In the case where the thermal member 4 of the automobile comprises a fuel cell, the exchangers 10, 11 may be used to regulate the temperature of the gases supplying the fuel cell, in particular to heat the inlet gases of the fuel cell so that they are at a temperature which is close to the operating temperature of the fuel cell. Moreover, the exchangers 17, 18 may be used, in turn, to cool the outlet gases, or waste gases, of the fuel cell and thus collect the water produced by the fuel cell and which is present in the form of vapor in the outlet gases.

Thus, the condensation of the water produced by the fuel cell and contained in the waste gases makes it possible to obtain a more advantageous water balance in the automobile.

In the remainder of the description, the thermal member 4 is assumed to comprise a fuel cell.

The cooling device 1 and, in particular, the valves 19, 21 and 23 are controlled by an on-board electronic control unit 25 of which the overall structure is illustrated in FIG. 2.

The electronic control unit 25 receives, at the inlet, measuring signals from the main elements of the cooling device 1. Thus the electronic control unit 25 receives a signal T1 from the temperature sensor 7 which measures the temperature of the coolant at the outlet of the thermal member, and a signal T2 from the temperature sensor 13 which measures the temperature of the coolant from the secondary circuit 3 downstream of the first and second assemblies 9, 16. The control unit also receives further signals from elements external to the cooling device 1, for example signals indicating the temperature of other elements or fluids circulating in the automobile and not shown.

The signals T1, T2 are provided to a second means which makes it possible to determine, from said signals T1 and T2, and further signals from external elements, the temperature of the coolant at the inlet of the first assembly 9 and of the second assembly 16, i.e. the temperature of the coolant at the inlet of each heat exchanger 10, 11, 17 and 18. To this end, the second means 26 assumes that the temperature of the coolant of the secondary circuit 3 remains approximately constant between the inlet and the outlet of the pump 12.

To determine the temperature of the coolant at the inlet of the first assembly 9, the second means 26 determines in a first step the temperature of the coolant at the outlet of the exchanger 5. To this end, it uses the signals T2 and T1 and the equations of the model of the exchanger 5 in a static state. The second means 26 may thus deduce therefrom the temperature of the fluid at the outlet of the exchanger 5.

In a second step, the second means 26 determines the temperature of the fluid at the outlet of the first radiator 8 from, in particular, mapping of the first radiator 8 and inlet and outlet temperatures of the second fluid (not shown) circulating in the first radiator, for example air. The second means 26 may thus provide at the outlet the temperature of the coolant at the inlet of the first assembly 9.

More particularly, the second means 26 may use a model (1) of the type:

T_{fc8}^{OUT}=f(Qₐᵢᵣ,Q_{fc8},Tₐᵢᵣ^{IN},Tₐᵢᵣ^{OUT},T_{fc8}^{IN})

in which :
Qₐᵢᵣ represents the flow rate of air passing through the radiator 8;
Q_{fc8} represents the flow rate of coolant passing through the radiator 8;
T_{fc8}^{OUT} represents the temperature of the coolant at the outlet of the radiator 8;
T_{fc8}^{IN} represents the temperature of the coolant at the inlet of the radiator 8 which is determined by the second means 26 according to the equations of the model of the exchanger 5 in a static state;
Tₐᵢᵣ^{IN} is the temperature of the air entering the radiator 8;
Tₐᵢᵣ^{OUT} is the temperature of the air leaving the radiator 8.

To determine the temperature of the coolant at the inlet of the second assembly 16, the second means 26 determines the temperature of the fluid at the outlet of the second radiator 15, from in particular mapping of the second radiator 15 (in a manner similar to the first radiator 8). The second means 26 may thus provide at the outlet the temperature of the coolant at the inlet of the second assembly 16.

The signals determined by the second means 26 are transmitted, therefore, to the first means 27. Said first means also receives the signals T2 from the temperature sensor 13. The first means 27 enables the outlet temperature of the coolant circulating in each heat exchanger 10, 11, 17 and 18 to be estimated. In particular, the second means 27 uses the dynamic equations of the heat exchangers which are expressed in the following vectorial form:

$$\{ \begin{matrix}{\dot{T}}_{i} = {A}_{i} \cdot {T}_{i} + {u}_{i} \cdot {B}_{i} \cdot {T}_{i} + {u}_{i} \cdot b + {v}_{i} \\ {T}_{fci}^{OUT} = C \cdot {T}_{i} - {T}_{fci}^{IN}\end{matrix} \qquad \begin{matrix}( 2 ) \\ ( 3 )\end{matrix}$$

in which:
Tᵢ represents the temperature vector of the exchanger i (i=10, 11, 17, 18):

$${T}_{i} = [ \begin{matrix}{T}_{fci} \\ {T}_{gi} \\ {T}_{pi}\end{matrix} ]$$

where T_{fci} represents the temperature of the coolant circulating in the exchanger i, T_{gi} represents the temperature of the gas which circulates in the exchanger i and of which the temperature is regulated by the exchanger i, and Tₚᵢ represents the temperature of the walls of the exchanger i;
\dot{T}ᵢ represents the variation relative to the time of the temperature vector Tᵢ;
_{fci}^{IN} and T_{fci}^{OUT} represent respectively the inlet and outlet temperatures of the coolant circulating in the exchanger i;
Aᵢ and Bᵢ represent characteristic matrices of the exchanger i and depending on the flow rate of gas which circulates in the exchanger i and of which the temperature is regulated by the exchanger i;
uᵢ represents the vector:

$${v}_{i} = ɛ \cdot [ \begin{matrix}{T}_{fci}^{IN} \\ {T}_{gi}^{IN} \\ 0\end{matrix} ]$$

where ε depends on the flow rate of gas which circulates in the exchanger i and of which the temperature is regulated by the exchanger i;
b represents a characteristic vector of the exchanger i;
C represents the vector: C=[1 0 0]; and
uᵢ represents the flow rate of coolant circulating in the exchanger i.

The inlet temperatures T_{fc10}^{IN} and T_{fc11}^{IN} of the coolant in the exchangers 10 and 11 are equal to the temperature T_{fc8}^{OUT} of the coolant at the outlet of the radiator 8, T_{fc8}^{OUT} being determined by the second means 26. Moreover, the outlet temperatures of the coolants circulating in the different exchangers are linked by the formula:

$$T 2 = \frac{{Q}_{fc 10} \cdot {T}_{fc 10}^{OUT} + {Q}_{fc 11} \cdot {T}_{fc 11}^{OUT} + {Q}_{fc 17} \cdot {T}_{fc 17}^{OUT} + {Q}_{fc 18} \cdot {T}_{fc 18}^{OUT}}{{Q}_{fc 10} + {Q}_{fc 11} + {Q}_{fc 17} + {Q}_{fc 18}} \qquad ( 4 )$$

in which:
T_{fci}^{OUT} and Q_{fci} respectively represent the outlet temperature and the outlet flow rate of coolant circulating in the exchanger i.

Thus, from these different equations, from the inlet temperature of the coolant circulating in the exchangers 10, 11, 17, 18 determined by the second means 26, and from signals T2 from the temperature sensor 13, the first means 27 may use a state observer, preferably a high gain state observer, to estimate the outlet temperature T_{fci}^{OUT} of the coolant circulating in each exchanger of the first assembly 9 and of the second assembly 16.

More particularly, the state observer makes it possible to estimate, from the model of a heat exchanger, the temperature vector Tᵢ of the exchanger i, and in particular the outlet temperature T_{fci}^{OUT} of the coolant. By comparing the values obtained with the measured value T2, the first means 27 may correct the model and thus refine the value of the estimated temperature vector Tᵢ.

Thus it is possible to estimate the outlet temperature of each heat exchanger 10, 11, 17, 18 whilst limiting the number of temperature sensors in the cooling device.

The temperatures estimated by the first means 27 are thus provided to a third means 28 capable of controlling the valves 19, 21, and 23 of the different adjustable short-circuiting means, in particular by calculating the percentages of openings α19, α21 of said valves. The signals α19, α21 make it possible to control the proportion of the flow rate which has to pass through the radiators 8 and 15 respectively.

Thus, the third means 28 makes it possible to adapt the circulation of coolant in the secondary circuit 3, in order to improve the heat exchanges there.

According to one embodiment, the third means 28 may also be used to monitor the water balance, in particular by determining the water collected by the exchangers 17, 18 in the waste gases from the fuel cell.

The water balance during a period T is provided by the following relation:

$$B = {{\int }_{0}}^{T} ( {\sum }_{exchangersE} {Q}_{i}^{1} - {Q}^{2} ) d t \qquad ( 5 )$$

in which Qᵢ¹ denotes the flow rate of water condensed in the heat exchanger i and Q² is the flow rate of water consumed by the reformer. More particularly, the flow rate Qᵢ¹ of water condensed in the heat exchanger i may be calculated from the equation:

Qᵢ¹=f(Qᵢ^{IN}(vapor); Pᵢ^{IN}(gas); Tᵢ^{IN}(gas); Tᵢ(gas)) (6)

in which:
Qᵢ^{IN}(vapor) is the flow rate of vapor at the inlet of the exchanger i;
Pᵢ^{IN}(gas) is the pressure of the gases at the inlet of the exchanger i;
Tᵢ^{IN} (gas) is the temperature of the gases at the inlet of the exchanger i;
Tᵢ (gas) is the average temperature of the gases in the region of the exchanger i;

Moreover, the flow rate Q² of water consumed by the reformer may be calculated by the formula:

$${Q}^{2} = \frac{x}{{PCI}_{fuel}} \cdot \frac{S}{C} \cdot \frac{{PCI}_{H 2}}{η} \cdot {R}_{a} \cdot {N}_{cell} \cdot \frac{I}{2 \cdot F} \qquad ( 7 )$$

in which:
F is the Faraday constant;
N_{cell} is the number of cells of the fuel cell;
η is the efficiency of the reformer;
the ratio S/C represents the flow rate of water relative to the flow rate of carbon;
I is the electrical current supplied by the fuel cell;
Rₐ is the anodic stoichiometry;
PCI_{fuel} represents the lower calorific power of the fuel entering the reformer;
PCI_{H2} represents the lower calorific power of the hydrogen leaving the reformer;
x is the proportion of carbon in the fuel supplying the reformer (of the formula CₓH_{y}O_{z}).

The calculation of B thus makes it possible to avoid the addition of a supplementary sensor to detect the level of water downstream of the reformer. Moreover, by comparing the value of B to a predefined threshold, it is also possible to make a diagnosis about the consumption of water by the fuel cell and about the capacity of the water tank.

According to a second embodiment of the invention, the cooling device may also comprise two additional temperature sensors capable of measuring the temperature of the coolant at the inlet of the first assembly 9 and at the inlet of the second assembly 16. In this case, the electronic control unit 25 no longer comprises second means 26 to determine the temperature of the coolant at the inlet of the first assembly 9 and of the second assembly 16: the first means 27 directly receives the variables measured by the temperature sensor 13 and by the temperature sensors of the coolant at the inlet of the first and second assemblies.

In this embodiment, the electronic control unit may, however, also comprise a fourth means (not shown) to diagnose a breakdown of an adjustable valve.

More particularly, the fourth means uses the models of the radiators 8, 15 and/or the model of the heat exchanger 5 to determine the flow rate of coolant passing through said radiator 8, 15 or heat exchanger 5 and thus diagnose by comparison with the signals α19, α21, α23 for controlling the valves 19, 21, 23, a potential breakdown of one of said valves 19, 21, 23.

For example, by reversing the equation (1) of the model of the radiator 8 and with the knowledge of the outlet temperature T_{fc8}^{OUT} of the radiator 8 (measured by a temperature sensor) it is possible to calculate Q_{fc8} and to compare this value with α19. It is also possible to calculate a value representative of the difference e₈ between the determined value of the flow rate Q_{fc8} and the controlled value α19:

e₈=(Q_{fc8}−α₁₉·Q₉)² (8)

in which Q₉ represents the flow rate of coolant through the first assembly 9.

Similarly, it is also possible to compare the flow rate Q_{fc15} and to compare it with the value α21, by calculating, for example, the variable e₁₅:

e₁₅=(Q_{fc15}−α₂₁·Qhd 16)² (9)

in which Q₁₆ represents the flow rate of coolant through the second assembly 16.

In particular, the total flow rate Q_{fc} of coolant in the secondary circuit 3 is:

Q_{fc}=Q₉+Q₁₆ (10)

Similarly, it is also possible to compare the flow rate Q_{fc5} and to compare it with the value α23, by calculating, for example, the variable e₅:

e₅=(Q_{fc5}−α₂₃·Q₉)² (11)

From the various differences calculated and from the threshold values, the fourth means may implement a method for monitoring the cooling circuit.

One exemplary embodiment of the method for monitoring the secondary cooling circuit by the fourth means is illustrated by the diagram of FIG. 3.

The process starts with a step 29 for determining the flow rates Q_{fc5}, Q_{fc8} and/or Q_{fc15} of coolant respectively supplying the heat exchanger 5, the radiator 8 and/or the radiator 15.

During a step 30, the fourth means calculates the difference e₅ defined above, then compares the value obtained with a threshold value S₁ which has been stored or determined according to operating parameters of the fuel cell.

If the difference e₅ is greater than the threshold value S₁, then the method continues with a step 31 during which the temperature T1 of the coolant circulating in the main circuit 2 is compared with a threshold value S₂. If the temperature T1 is greater than the threshold S₂ then the cooling device does not enable the heat emitted by the thermal member to be correctly discharged and the vehicle can be stopped during a step 32. If the value T1 is lower than the threshold S₂, an alarm signal may be triggered and the process starts again with the step 29.

If the difference e₅ is less than or equal to the threshold value S₁, then the flow rate circulating in the heat exchanger 5 corresponds to the setpoint value α23 and there is no notable leakage or breakdown in the third adjustable means. The method continues with a step 33.

During the step 33, the fourth means calculates the difference e₈ and/or e₁₅ defined above, then respectively compares the value(s) obtained with the threshold value(s) S₈ et S₁₅ stored or determined according to operating parameters of the fuel cell.

If the difference e₈, respectively e₁₅, is greater than the threshold S₈, respectively S₁₅, then the method continues with a step 34 during which the temperature T2 of the coolant circulating in the secondary circuit 3 is compared with a threshold value S₃. If the temperature T2 is greater than the threshold S₃ then the secondary circuit 3 does not enable the heat from the main circuit to be redistributed correctly, and the valve 19, respectively 21, is fully opened (α19=1, respectively α21=1) during a step 35.

If the value T2 is less than or equal to the threshold S₃ an alarm signal may be triggered and the method continues with step 29.

Thus by different means of the electronic control unit 25, it is possible to monitor and possibly to reconfigure the control of the cooling device 1 whilst limiting the number of sensors therein.

1-10. (canceled)

11. A cooling device for a thermal member for a traction system of an automobile, comprising:
a main cooling circuit to regulate a temperature of the thermal member;
a secondary cooling circuit comprising a first assembly of at least two heat exchangers mounted in parallel, and a thermal coupling means between the main cooling circuit and the secondary cooling circuit;
a temperature sensor mounted in series on the secondary cooling circuit and downstream of the first assembly; and
a control unit comprising means for estimating, with a state observer, an outlet temperature of each heat exchanger of the first assembly from an inlet temperature of coolant at an inlet of each heat exchanger of the first assembly and variables measured by the temperature sensor.

12. The device as claimed in claim 11, in which the secondary cooling circuit comprises a bypass of which one end is mounted downstream of the temperature sensor and upstream of the thermal coupling means, and of which the other end is mounted downstream of the first assembly of heat exchangers and upstream of the temperature sensor, the bypass comprising a second assembly of at least two heat exchangers mounted in parallel.

13. The device as claimed in claim 12, in which the means for estimating estimates, with a state observer, the outlet temperature of each heat exchanger of the second assembly from the inlet temperature of the coolant at the inlet of each heat exchanger of the second assembly and variables measured by the temperature sensor.

14. The device as claimed in claim 12, in which the secondary cooling circuit also comprises first and second radiators respectively associated with the first and second assemblies of exchangers.

15. The device as claimed in claim 14, further comprising adjustable means for short-circuiting the first and second radiators,
wherein the control unit includes means for controlling the adjustable means for short-circuiting the first and second radiators.

16. The device as claimed in claim 15, in which the second assembly of exchangers enables the temperature of the outlet gases from the fuel cell to be regulated and in which the means for controlling controls the adjustable means to short-circuit the second radiator depending on the water balance consumed by the fuel cell and collected by the cooling device.

17. The device as claimed in claim 14, further comprising temperature sensors to measure the inlet temperature of the coolant at the inlet of each assembly of heat exchangers,
wherein the control unit comprises means for monitoring the flow rate of coolant circulating in the first and second radiators from variables measured by the temperature sensors.

18. The device as claimed in claim 11, in which the thermal member comprises a fuel cell and in which the thermal coupling means is a heat exchanger arranged between the main cooling circuit and the secondary cooling circuit.

19. The device as claimed in claim 11, in which the control unit comprises means for determining the inlet temperature of the coolant at the inlet of each heat exchanger from variables measured by the temperature sensor.

20. A method for controlling a device for cooling a thermal member for a traction system of an automobile, comprising a main cooling circuit to regulate a temperature of the thermal member, a secondary cooling circuit comprising a first assembly of at least two heat exchangers mounted in parallel and a thermal coupling means between the main cooling circuit and the secondary cooling circuit, comprising:
measuring a temperature of coolant downstream of the first assembly of heat exchangers;
determining a temperature of the coolant of the secondary circuit at an inlet of the heat exchangers; and
estimating, with a state observer, an outlet temperature of each of the heat exchangers from the inlet temperature of the coolant at the inlet of the heat exchangers and the measured temperature of the coolant.
